(19) United States
(12) Patent Application Publication
(10) Pub. No.: US 2016/0187968 A1
(43) Pub. Date: Jun. 30, 2016

(54) ELECTRONIC DEVICE AND FUNCTION CONTROL METHOD THEREOF

(71) Applicant: Chiun Mai Communication Systems, Inc., New Taipei (TW)

(72) Inventor: Yi-Chieh Chiu, New Taipei (TW)

(21) Appl. No.: 14/979,492

(22) Filed: Dec. 27, 2015

(30) Foreign Application Priority Data
Dec. 27, 2014 (CN) 201410825176.0

(51) Int. Cl. G06F 3/01

(52) U.S. Cl. CPC G06F 3/011

(57) ABSTRACT

An electronic device having a processor, a contact sensor, a blow sensor, and a storage device is disclosed. The processor senses at least one contact position via the contact sensor. The processor senses a blow action via the blow sensor. Then, the processor determines, based on the at least one contact position and/or the blow action, a predefined function and performs the predefined function.

### CROSS-REFERENCE TO RELATED APPLICATIONS

This application claims priority to Chinese Patent Application No. 201410825176.0 filed on Dec. 27, 2014, the contents of which are incorporated by reference herein.

### FIELD

The subject matter herein generally relates to controlling functions of an electronic device.

### BACKGROUND

Touch screens are popular for use as displays and as user input devices on portable devices, such as mobile telephones, tablets and personal digital assistants (PDAs).

### BRIEF DESCRIPTION OF THE DRAWINGS

Implementations of the present technology will now be described, by way of example only, with reference to the attached figures.

FIG. 1 is a block diagram of one embodiment of an electronic device including a function control system.

FIG. 2 is a diagrammatic view of one embodiment of an electronic device having a contact sensor.

FIG. 3 illustrates a flowchart of one embodiment of a function control method for the electronic device of FIG. 1.

FIG. 4 is a diagrammatic view of one embodiment of a contact mode.

FIG. 5 is a diagrammatic view of another embodiment of a contact mode.

FIG. 6 is a diagrammatic view of another embodiment of a contact mode.

FIG. 7 is a diagrammatic view of another embodiment of a contact mode.

FIG. 8 is a diagrammatic view of another embodiment of a contact mode.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

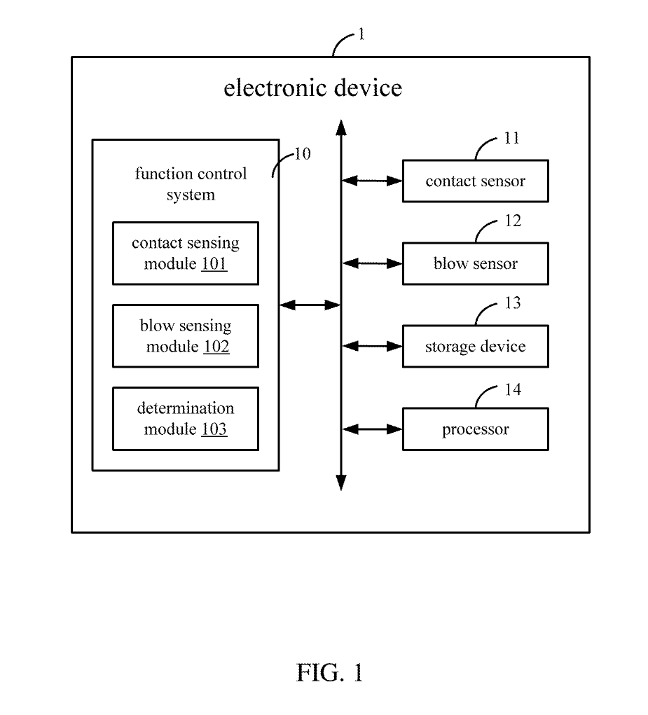

FIG. 1 illustrates an embodiment of an electronic device 1 including a function control system 10. In the embodiment, the electronic device 1 can include a contact sensor 11, a blow sensor 12, a storage device 13, and a processor 14. The storage device 13 can store a plurality of instructions. When the plurality of instructions are executed by the processor 14, the processor 14 senses at least one contact position via the contact sensor 11. The processor 14 senses a blow action via the blow sensor 12. The processor 14 determines a predefined function based on the at least one contact position and/or the blow action, and perform the predefined function.

When the contact sensor 11 detects the at least one contact position, the processor 14 can determine a contact mode based on the at least one contact position. In at least one embodiment, the processor 14 can compare the at least one contact position with a plurality of contact modes stored in the storage device 13

When the user blows on the blow sensor 12, the blow sensor 12 can detect the blow action of the user and the processor 14 can determine a blow mode for the blow action. In at least one embodiment, the processor 14 can compare the blow action with a plurality of blow modes stored in the storage device 13.

In at least one embodiment, the blow sensor 12 can be a sound sensor. In at least one embodiment, the blow sensor 12 can be a microphone. When the user blows at the microphone, the microphone can detect the sound of the blow. Therefore, the processor 14 can determine sound information of the received sound of the blow. The sound information can include sound intensity and length of the received sound of the blow. The processor 14 can set the sound intensity and the length of the blow as the blow intensity and the length of the blow.

In at least one embodiment, the processor 14 can generate the sound intensity by the decibel (db) measurement. When the processor 14 determines a db value of the received sound, the processor 14 can set the db value of the received sound as the sound intensity. In at least one embodiment, since the db value of the received sound may be continuously changed due to an unstable blow, the processor 14 can set the maximum db value of the received sound representing the blow intensity.

In at least one embodiment, the processor 14 can generate the length of the blow by time measurement. When the processor 14 detects the sound of the blow, the processor 14 can begin to measure a counted time. In at least one embodiment, the processor 14 can determine the blow mode according to the db value of the received sound and/or the counted time. For example, the processor 14 can compare the db value of the received sound with a predetermined db value and compare the counted time with a predetermined time to determine the blow mode.

In at least one embodiment, the processor 14 can determine the predefined function to perform the predefined function based on at least one contact position, the blow action, or a combination of at least one contact position and the blow action. In at least one embodiment, the processor 14 can determinate the predefined function based on at least one of the contact mode and the blow action. In at least one embodiment, the processor 14 can determinate the predefined function based on at least one contact position, the sound information, or a combination of the at least one contact position and the sound information. In at least one embodiment, the processor 14 can determinate the predefined function based on at least one of the contact mode and the blow mode.

In at least one embodiment, the processor 14 can look up a mapping table stored in the storage device 13 based on the at least one contact position and/or the blow action to select the predefined function. In at least one embodiment, the storage device 13 stores a plurality of device functions including the predefined function corresponding to the at least one contact position and/or the blow action. In the embodiment, the mapping table can include mapping data between the device functions and the combinations of the contact modes and the blow modes for different applications.

The storage device 13 can be a non-volatile computer readable storage medium that can be electrically erased and reprogrammed, such as read-only memory (ROM), random-access memory (RAM), erasable programmable ROM (EPROM), electrically EPROM (EEPROM), hard disk, solid state drive, or other forms of electronic, electromagnetic, or optical recording medium. In at least one embodiment, the storage device 13 can include interfaces that can access the aforementioned computer readable storage medium to enable the electronic device 1 to connect and access such computer readable storage medium. In at least one embodiment, the storage device 13 can be a smart media card, a secure digital card, or a flash card.

The processor 14 can be a processor, a central processor (CPU), a graphic processor (GPU), a system on chip (SoC), a field-programmable gate array (FPGA), or a controller for executing the program instruction in the storage device 14 which can be static RAM (SRAM), dynamic RAM (DRAM), EPROM, EEPROM, flash memory, or other types of computer memory. The processor 14 can further include an embedded system or an application specific integrated circuit (ASIC) having embedded program instructions.

In at least one embodiment, the electronic device 1 can include a display. The display can show the execution of the predefined function. The display can comprise a display device using liquid crystal display (LCD) technology, or light emitting polymer display (LPD) technology, although other display technologies can be used in other embodiments.

In at least one embodiment, the electronic device 1 can be a mobile phone, a tablet, or other electronic device. FIG. 1 illustrates only one example of an electronic device 1, the electronic device in other embodiments can include more or fewer components than illustrated, or have a different configuration of the various components.

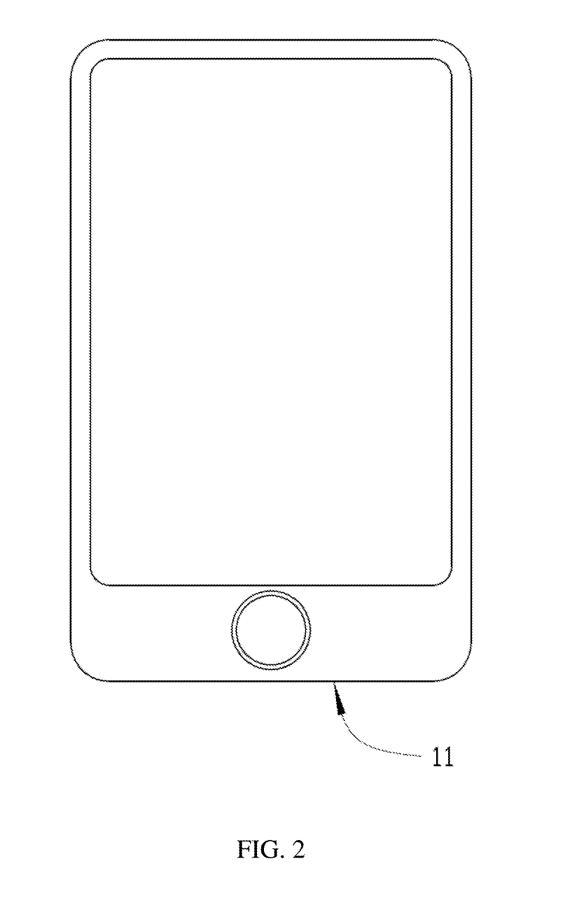

FIG. 2 illustrates an embodiment of function modules of the function control system 10 in the electronic device 1 of FIG. 1. In at least one embodiment, the function control system 10 can include one or more modules, for example, a contact sensing module 101, a blow sensing module 102, and a determination module 103. “Module,” as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable medium include CDs, DVDs, BLU-RAY, flash memory, and hard disk drives.

The contact sensing module 101 senses at least one contact position via the contact sensor 11. The blow sensing module 102 senses a blow action via the blow sensor 12. The determination module 103, based on the at least one contact position and/or the blow action, determines a predefined function to perform the predefined function.

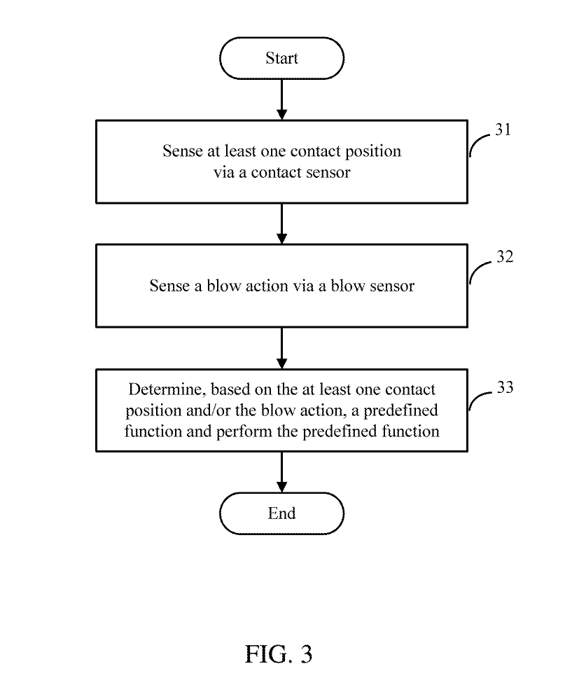

FIG. 3 illustrates a flowchart in accordance with an example embodiment. The example method is provided by way of example, as there are a variety of ways to carry out the method. The method described below can be carried out using the configuration illustrated in FIG. 1, for example, and various elements of these figures are referenced in explaining example method. Each block shown in FIG. 3 represents one or more processes, methods, or subroutines, carried out in the example method. Furthermore, the order of blocks is illustrative only and can change. Additional blocks can be added or fewer blocks can be utilized, without departing from this disclosure. The example method can begin at block 31.

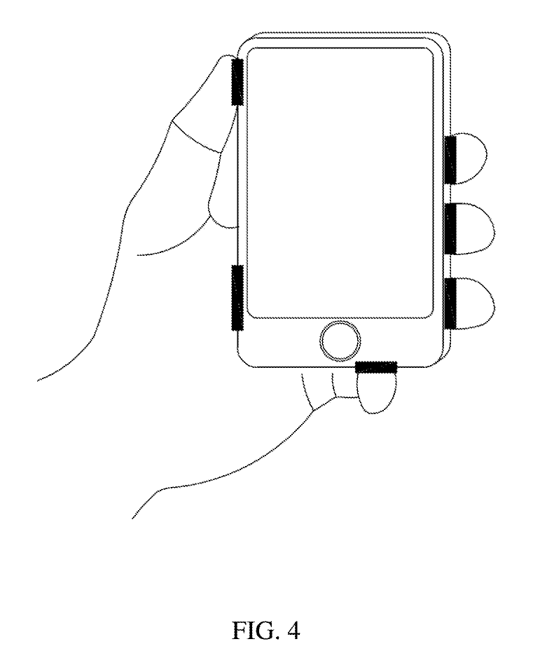

At block 31, the contact sensing module 101 senses at least one contact position via the contact sensor 11. Referring to FIG. 4, all fingers of the left hand of a user are in contact with the electronic device 1. One finger is in contact with the left side of the electronic device 1, another three fingers are in contact with the right side of the electronic device 1, and the other one finger is in contact with the bottom side of the electronic device 1. In addition, the palm of the hand is in contact with the left side of the electronic device 1. These six contact positions in FIG. 4 can be regarded as one of a plurality of contact modes.

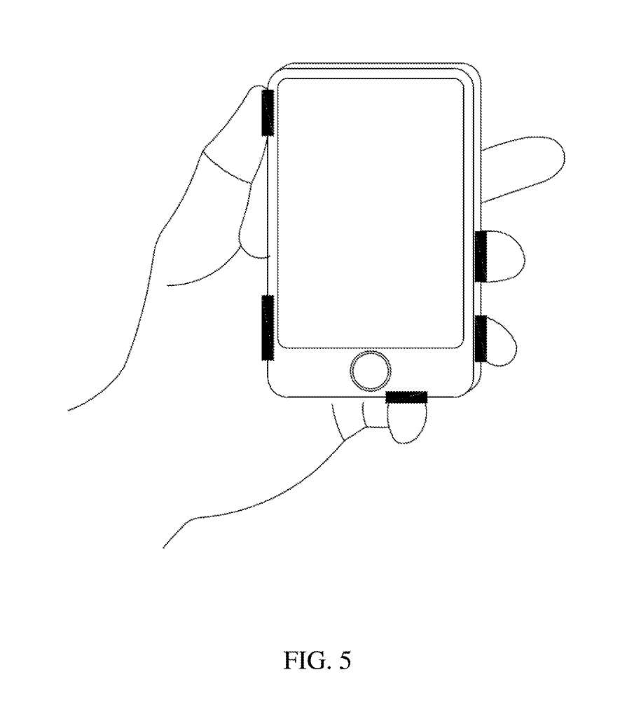

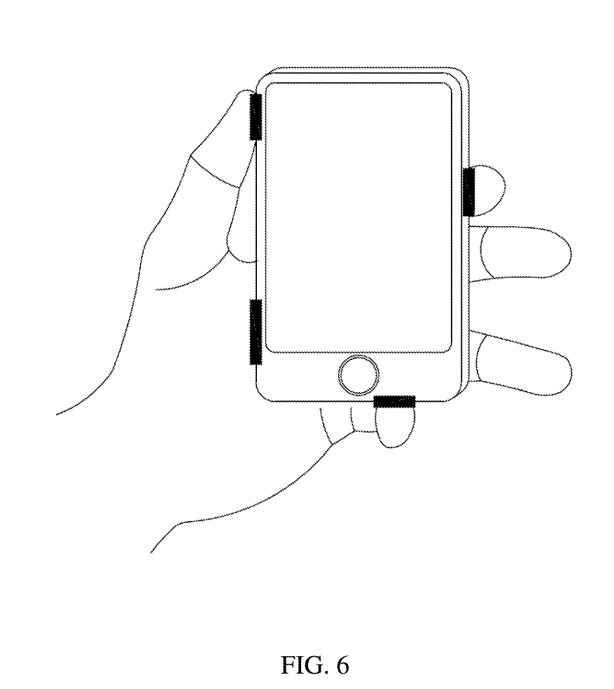

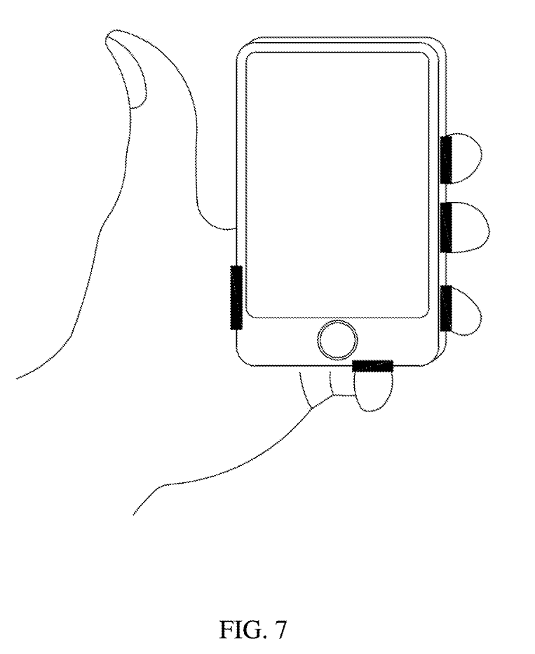

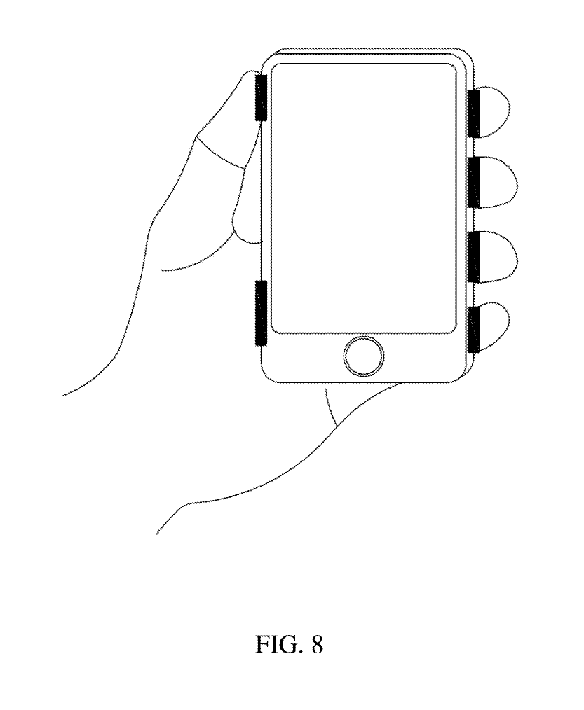

FIG. 5 illustrates one finger and the palm of the hand are in contact with the left side of the electronic device 1, another two fingers are in contact with the right side of the electronic device 1, and one other finger is in contact with the bottom side of the electronic device 1. FIG. 6 illustrates one finger and the palm of the hand are in contact with the left side of the electronic device 1, another finger is in contact with the right side of the electronic device 1, and one other finger is in contact with the bottom side of the electronic device 1. FIG. 7 illustrates the palm of the hand is in contact with the left side of the electronic device 1, three fingers are in contact with the right side of the electronic device 1, and one other finger is in contact with the bottom side of the electronic device 1. FIG. 8 illustrates one finger and the palm of the hand are in contact with the left side of the electronic device 1, and the other four fingers are in contact with the right side of the electronic device 1.

The contact positions in each of FIG. 4, FIG. 5, FIG. 6, FIG. 7 and FIG. 8 define a different contact mode. In other words, a contact mode is defined by the number of contact positions on each side of the electronic device 1. When the contact sensor 11 detects the at least one contact position, the contact sensing module 101 can determine a contact mode based on the at least one contact position. In at least one embodiment, the contact sensing module 101 can compare the at least one contact position with a plurality of contact modes stored in the storage device 13.

At block 32, the blow sensing module 102 senses a blow action via the blow sensor 12. When the user blows on the blow sensor 12, the blow sensor 12 can detect the blow action of the user and the blow sensing module 102 can determine a blow mode for the blow action. In at least one embodiment, the blow sensing module 102 can compare the blow action with a plurality of blow modes stored in the storage device 13.

In at least one embodiment, the blow sensor 12 can be a sound sensor, and the blow sensing module 102 can be a sound sensing module. In at least one embodiment, the blow sensor 12 can be a microphone. When the user blows on the sound sensor, the sound sensor can detect the sound of the blow. Therefore, the sound sensing module can determine sound information of the received sound of the blow. The sound information can include sound intensity and length of the received sound. The blow sensing module can set the sound intensity and the length of the received sound as the blow intensity and the length of the blow.

In at least one embodiment, the sound sensing module can generate the sound intensity by decibels (db) measurement. When the sound sensing module determines a db value of the received sound, the sound sensing module can set the db value of the received sound as the sound intensity. In at least one embodiment, since the db value of the received sound may be continuously changed due to an unstable blow, the sound sensing module can set the maximum db value of the received sound representing the blow intensity.

In at least one embodiment, the sound sensing module can generate the length of the blow by time measurement. When the sound sensing module detects the sound of the blow, the sound sensing module can begin to measure a counted time.

In at least one embodiment, the blow mode can be determined according to the db value of the received sound and/or the counted time. When the db value of the received sound is lower than a predetermined db value, the blow mode is regarded as a light blow. When the db value of the received sound is equal to or higher than the predetermined db value, the blow mode is regarded as a heavy blow. When the counted time is shorter than a predetermined time, the blow mode is regarded as a short blow. When the counted time is equal to or longer than the predetermined time, the blow mode is regarded as a long blow. Therefore, the blow mode can be a light blow, a heavy blow, a long blow, a short blow, a long and heavy blow, a short and heavy blow, a long and light blow, or a short and light blow.

At block 33, the determination module 103 determines, based on the at least one contact position and/or the blow action, a predefined function to perform the predefined function. In at least one embodiment, the determination module 103 can determine the predefined function based on the contact mode and/or the blow action. In at least one embodiment, the determination module 103 can determine the predefined functions based on the at least one contact position and/or the sound information. In at least one embodiment, the determination module 103 can determine the predefined functions based on the contact mode and/or the blow mode.

In at least one embodiment, the determination module 103 can look up a mapping table stored in the storage device 13 based on the at least one contact position and/or the blow action to select the predefined function. In at least one embodiment, the electronic device 1 stores a plurality of device functions including the predefined function corresponding to the at least one contact position and/or the blow action. In the embodiment, the mapping table can include mapping data between the device functions and the combinations of the contact modes and the blow modes for different applications. For example, the executed application is a media player application. When the detected contact mode is similar to the stored contact mode in FIG. 4, the determination module 103 can execute the media player application to play media. When the detected contact mode is similar to the stored contact mode in FIG. 5, the determination module 103 can stop the media player application from playing the media. When the detected contact mode is similar to the stored contact mode in FIG. 6, the determination module 103 pauses the media. In addition, when the detected contact mode is similar to the stored contact mode in FIG. 7 and the detected blow mode is a long blow, the determination module 103 can fast-forward the media.

In at least one embodiment, the executed application is an electronic book application. When the detected contact mode is similar to the stored contact mode in FIG. 5 and the detected blow mode is a short blow, the determination module 103 can execute the electronic book application to turn to the next page of the electronic book. When the detected contact mode is similar to the stored contact mode in FIG. 5 and the detected blow mode is a long blow, the determination module 103 can execute the electronic book application to fast-flip the electronic book.

In at least one embodiment, the user can perform the predefined function for the executed application on the electronic device 1 via the at least one contact position and/or the blow action. Therefore, the number of the control methods for the electronic device 1 can be increased to improve the user experience.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. An electronic device, comprising:
a contact sensor;
a processor; and
a storage device that stores a plurality of instructions that, when executed by the processor, causes the processor to:
detect, on the contact sensor, at least one contact position;
determine, in response to the at least one contact position, a predefined function; and
perform the predefined function.

2. The electronic device according to claim 1, further comprising instructions to cause the processor to:
determine, in response to the at least one contact position, a contact mode; and
determine, in response to the contact mode, the predefined function.

3. The electronic device according to claim 2, wherein the contact mode is defined by a number of contact positions on each side of the electronic device.

4. An electronic device, comprising:
a blow sensor;
a processor; and
a storage device that stores a plurality of instructions that, when executed by the processor, causes the processor to:
detect, by the blow sensor, a blow action;
determine, in response to the blow action, a predefined function; and
perform the predefined function.

5. The electronic device according to claim 4, wherein the blow sensor is a sound sensor.

6. The electronic device according to claim 5, further comprising instructions to cause the processor to:
detect, by the sound sensor, a sound information of the blow action; and
determine, in response to the sound information, the predefined function.

7. The electronic device according to claim 6, wherein the sound information includes sound intensity of the blow action and the electronic device further comprises instructions to cause the processor to:
determine, by comparing the sound intensity of the blow action with a predetermined value, a blow mode; and
determine, in response to the blow mode, the predefined function.

8. The electronic device according to claim 6, wherein the sound information includes a length of the blow action and the electronic device further comprises instructions to cause the processor to:
determine, by comparing the length of the blow action with a predetermined time, a blow mode; and
determine, in response to the blow mode, the predefined function.

9. The electronic device according to claim 6, wherein the sound information includes sound intensity and a length of the blow action and the electronic device further comprises instructions to cause the processor to:
determine, by comparing the sound intensity of the blow action with a predetermined value and comparing the length of the blow action with a predetermined time, a blow mode; and
determine, in response to the blow mode, the predefined function.

10. An electronic device, comprising:
a contact sensor;
a blow sensor;
a processor; and
a storage device that stores a plurality of instructions that, when executed by the processor, causes the processor to:
detect, on the contact sensor, at least one contact position;
detect, by the blow sensor, a blow action;
determine, in response to the at least one contact position and the blow action, a predefined function; and
perform the predefined function.
